(19) United States
(12) Patent Application Publication
(10) Pub. No.: US 2025/0390811 A1
(43) Pub. Date: Dec. 25, 2025

(54) Legal Help at Your Fingertips. Get On-Demand Access to Legal Experts

(71) Applicants: Anoop SureshNair, Aurora, CO (US); Abishek Nair, Vallejo, CA (US)

(72) Inventors: Anoop SureshNair, Aurora, CO (US); Abishek Nair, Vallejo, CA (US)

(21) Appl. No.: 18/751,274

(22) Filed: Jun. 23, 2024

(51) Int. Cl. G06Q 10/0631; G06Q 30/0282

(52) U.S. Cl. CPC G06Q 10/063112; G06Q 30/0282

(57) ABSTRACT

The invention “Legal Help at Your Fingertips. Get On-Demand Access to Legal Experts” is a mobile and web application called Caunsel, providing affordable, on-demand legal advice. It connects users with legal experts through a user-friendly interface, matching system, and real-time communication tools, including chat and video call. The platform supports secure payments and user feedback, offering a cost-effective solution for accessing legal help while providing an income opportunity for lawyers and attorneys, especially junior ones.

### BACKGROUND OF THE INVENTION

### Problem to be Solved

The common person often has very low knowledge about legal matters and navigating the legal system. Access to legal advice and services is typically expensive, making it difficult for many to afford the help they need. Lawyers and attorneys usually charge high fees, which are unaffordable for many people. There are also limited options for accessible and affordable legal help for simple to medium legal questions. This invention aims to provide a platform for affordable and accessible legal help on-demand. It enables users to get legal advice for a reasonable cost, addressing simple to medium legal questions. This platform also offers lawyers and attorneys, especially junior lawyers, an opportunity to earn extra income as a side hustle if they have spare time.

### Field of the Innovation

The invention is related to legal technology, specifically a mobile or web application that connects users with legal experts for on-demand legal advice. It leverages technology to bridge the gap between legal professionals and those in need of legal assistance.

### Existing Solutions

Existing products and services offering legal advice typically include traditional law firms, online legal consultation services, and automated legal advice platforms. However, these solutions often come with high costs or provide limited interaction with real legal experts. This invention differs by offering a more cost-effective solution with direct access to real legal experts, providing personalized advice for a wide range of legal issues. It also supports junior lawyers by offering them a platform to earn extra income and gain experience.

### SUMMARY OF THE INVENTION

The invention is a mobile or web application named “Caunsel.” It provides users with access to legal experts for on-demand legal advice at a reasonable cost. The platform consists of a user interface for clients to submit legal questions, a matching system that connects clients with available lawyers or attorneys, and a communication system for providing legal advice (chat, video call, etc.). Users create an account, describe their legal issue, and are matched with a suitable legal expert. They receive advice through the platform's communication tools, with pricing based on the complexity and length of the consultation

### BRIEF DESCRIPTION OF DRAWINGS

FIG. 1: An interface layout of the home screen.

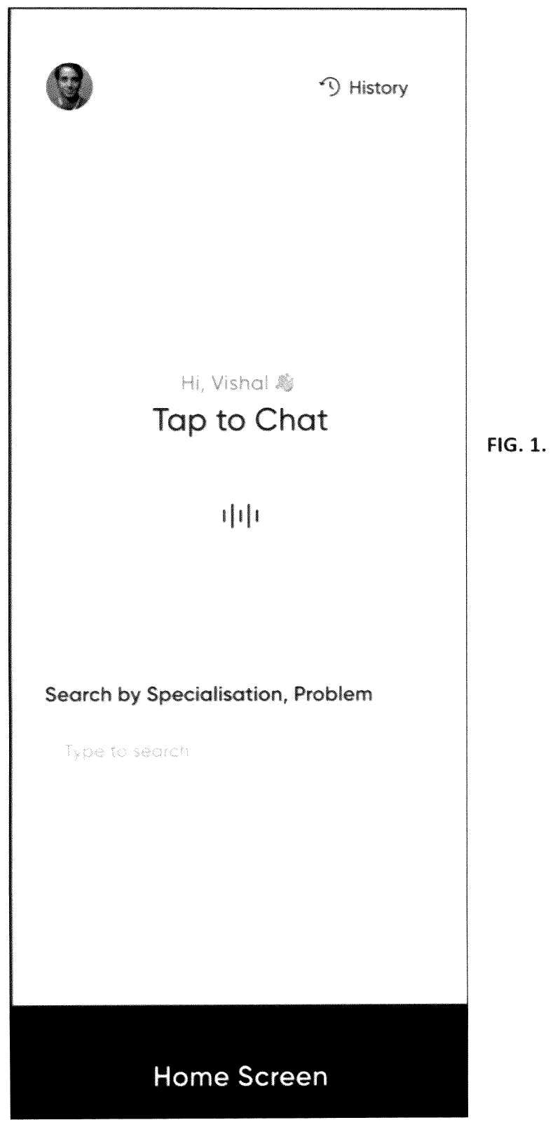

FIG. 2: An interface layout showing the initial message with direct call or chat option.

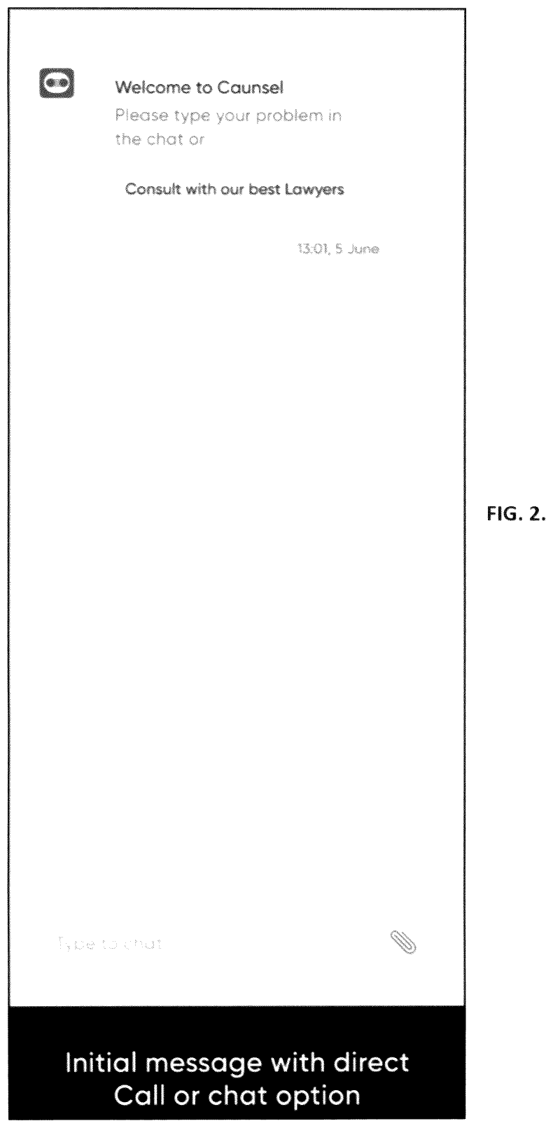

FIG. 3: An interface layout showing the ability to search specialization.

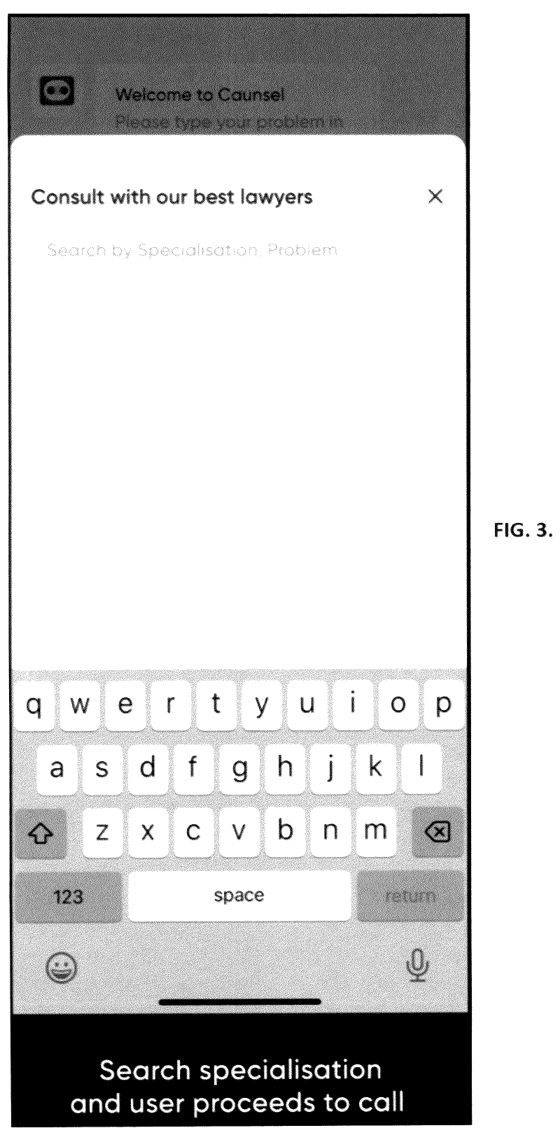

FIG. 4: An interface layout showing the user continuing to chat

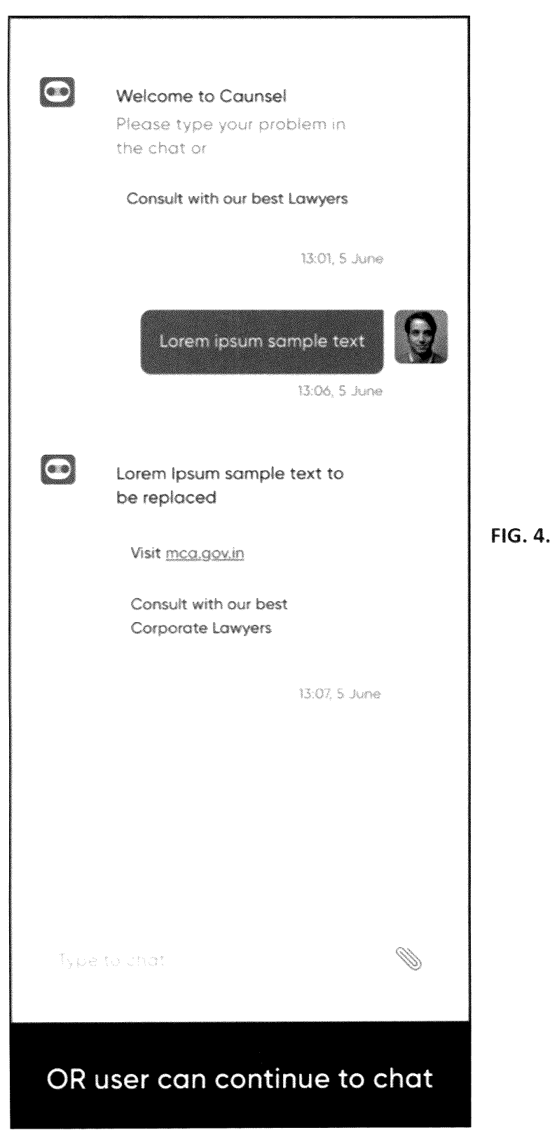

FIG. 5: An interface layout showing the user connecting with lawyers which also shows the estimated time and encryption notice that promotes privacy

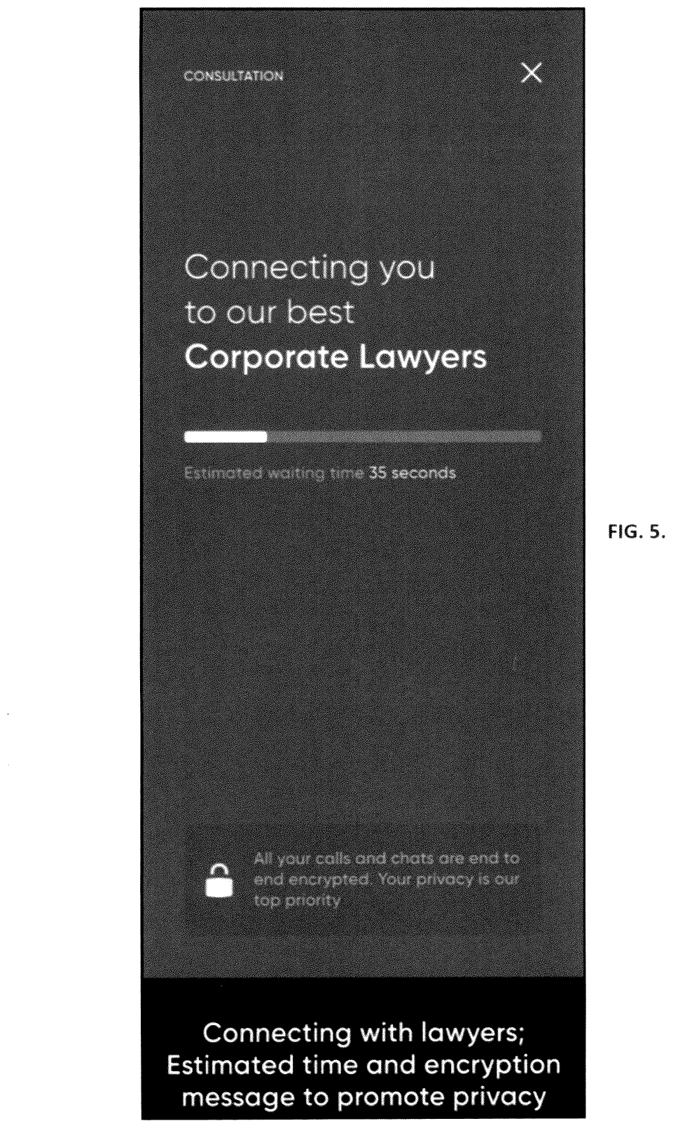

FIG. 6: An interface layout showing the screen that connects with the lawyer and shows the details of the lawyer

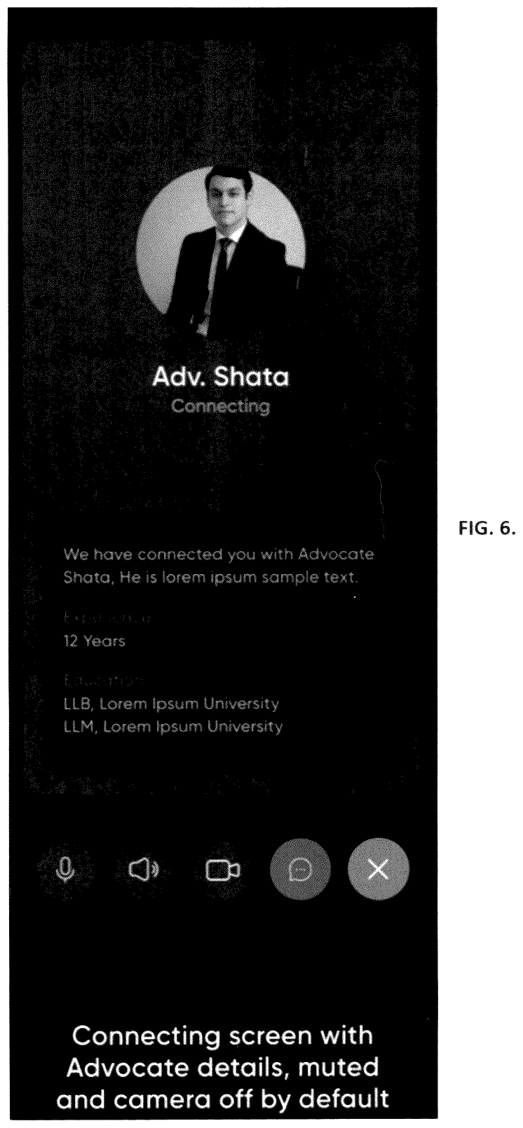

FIG. 7: An interface layout showing how the video interaction works

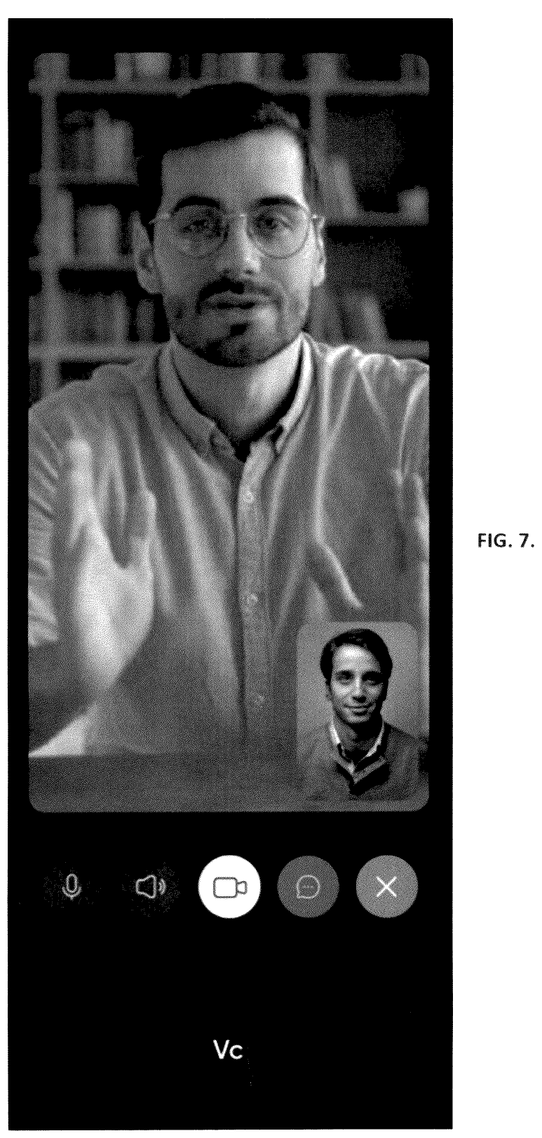

FIG. 8: An interface layout showing the chat window only available during the call session to exchange any documents or texts at real time

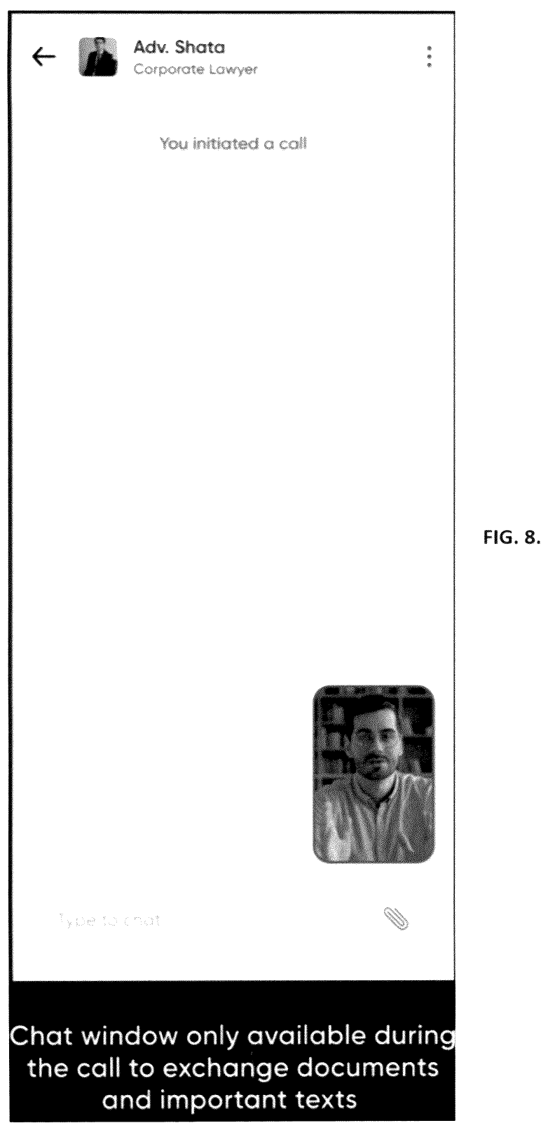

FIG. 9: An interface layout showing the screen when the call gets disconnected due to uncontrollable external issues

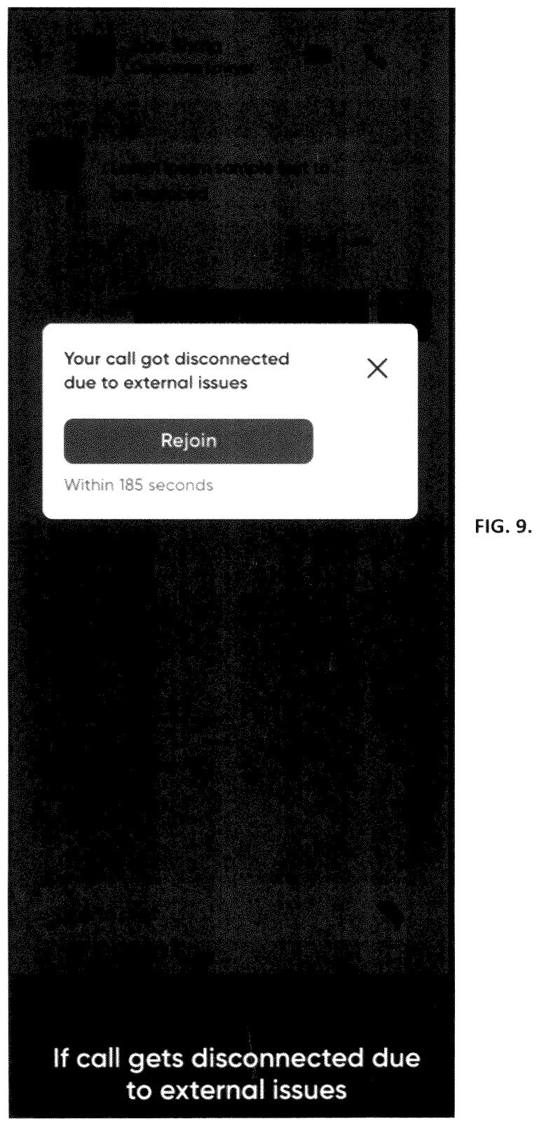

FIG. 10: An interface layout showing the feedback screen after a call is ended in a normal fashion

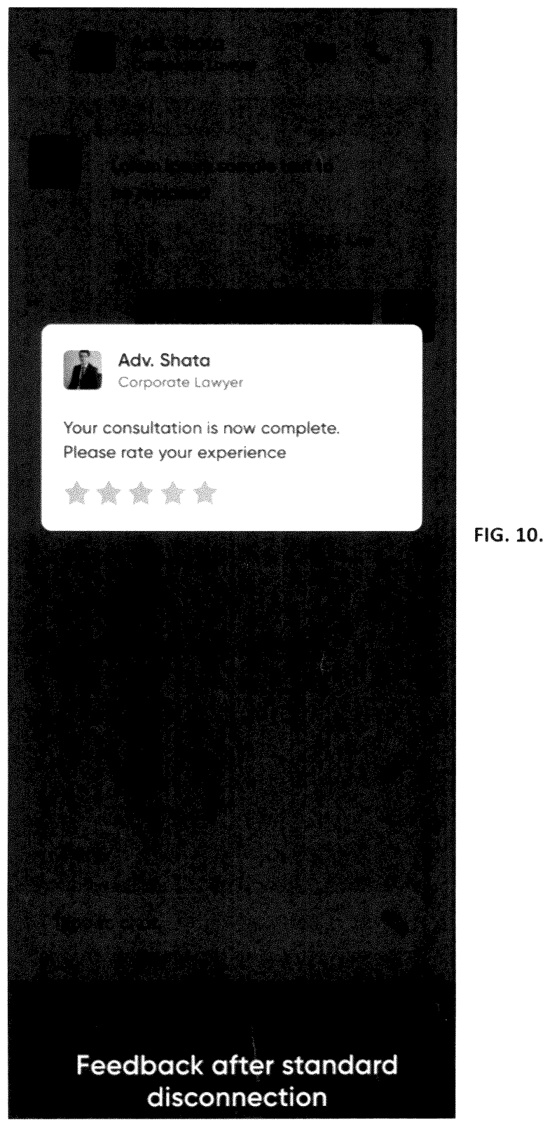

FIG. 11: An interface layout showing the user's history page that shows the historical conversations with different lawyers

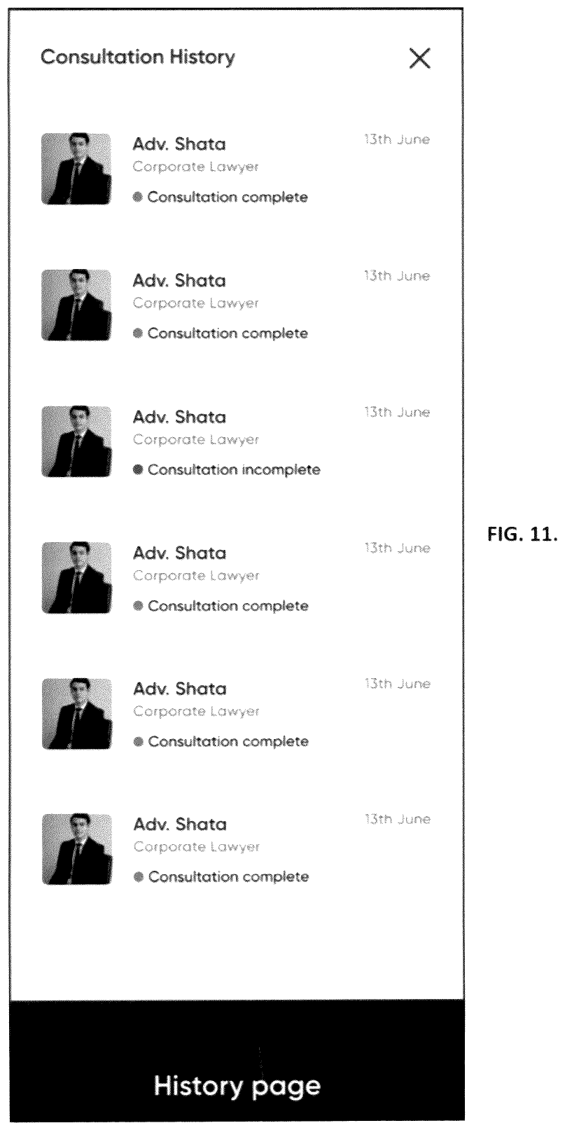

FIG. 12: An interface layout showing a history record in detail. This screen is shown when the user selects a history record from FIG. 11.

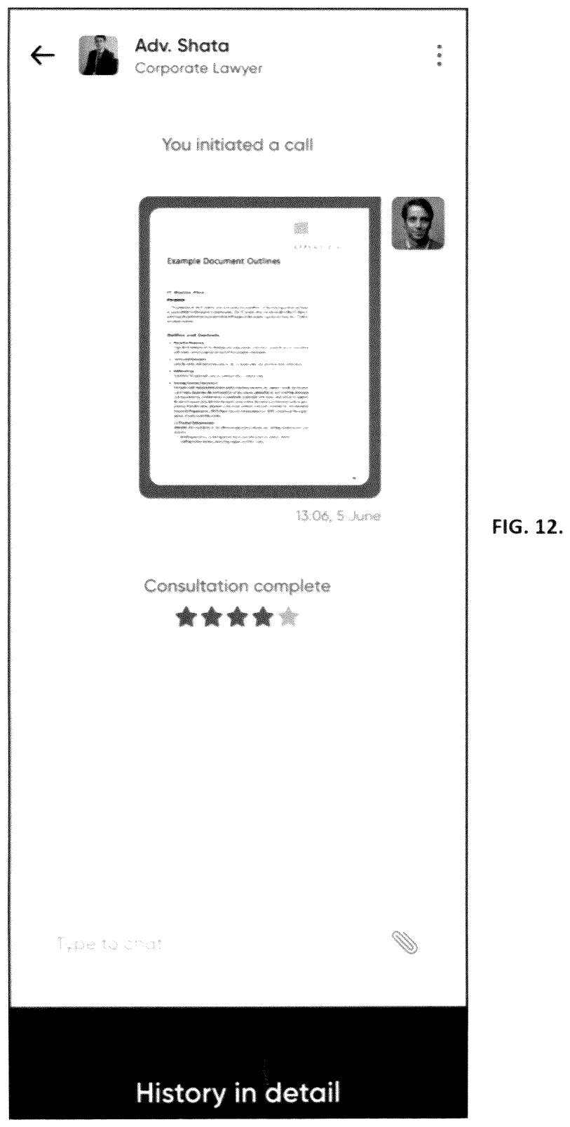

### DETAILED DESCRIPTION OF THE INVENTION

### User Interface

An intuitive interface allowing users to sign up, submit legal questions, and receive responses. Includes fields for question details and options for preferred communication methods (chat, video call).

### Matching System

An algorithm that matches user queries with available legal experts based on expertise, availability, and user preferences.

### Communication System

Integrated tools for real-time chat and video consultations, enabling users to interact directly with legal experts.

### Payment System

Secure payment gateway that handles transactions between users and legal experts, ensuring fair and transparent pricing

### Rating and Review System

Allows users to rate their experience with legal experts, providing feedback to improve service quality.

The platform is developed as a mobile app for IOS and Android devices, and a web application accessible via common web browsers. The backend is built with scalable server infrastructure to handle user queries and expert consultations. Users download the app or visit the website, create an account, and start submitting legal questions. Legal experts register on the platform, set their availability, and accept queries based on their expertise.

1. A system for providing on-demand legal advice, comprising:
A user interface for submitting legal questions;
A matching system for connecting users with legal experts;
A communication system for real-time interaction between users and legal experts.

2. The system of claim 1, wherein the user interface includes options for chat and video call consultations.

3. The system of claim 1, wherein the matching system uses an algorithm based on expertise, availability, and user preferences.

4. The system of claim 1, further comprising a payment system for handling transactions.

5. The system of claim 1, further comprising a rating and review system for user feedback.
